(19) United States
(12) Patent Application Publication
(10) Pub. No.: US 2001/0012601 A1
(43) Pub. Date: Aug. 9, 2001

(54) Surface treatment agent for resist pattern, and patterning process

(76) Inventors: Toshihiko Fujii, Usui-gun (JP); Hideto Kato, Usui-gun (JP)

Correspondence Address: MILLEN, WHITE, ZELANO & BRANIGAN, P.C., Arlington Courthouse Plaza I, Suite 1400, 2200 Clarendon Boulevard, Arlington, VA, 22201, US

(21) Appl. No.: 09/772,001

(22) Filed: Jan. 30, 2001

(30) Foreign Application Priority Data
Jan. 31, 2000 (JP) 2000-021103

(51) Int. Cl. G03C 5/00

(52) U.S. Cl. 430/322

(57) ABSTRACT

A surface treatment agent comprises an oligomeric or polymeric silicon-containing compound having an epoxycyclohexyl, glycidoxy, N-β-aminoethylamino, amino, N-phenylamino, mercapto or isocyanate group. When the surface treatment agent is applied to a metal or metal oxide substrate prior to formation of a resist pattern thereon, it serves to strengthen adhesion between the substrate and the photoresist film.

### BACKGROUND OF THE INVENTION

1. Field of the Invention

The present invention relates to a patterning process for forming a resist pattern on a substrate, especially a metal or metal oxide substrate, in the fabrication of various types of microelectronic devices. The invention also relates to an adhesive strength-enhancing surface treatment agent for use in such a resist patterning process.

2. Prior Art

The trend in recent years toward higher circuit density in electronic devices has increased the need for microfabrication technology. A number of surface treatment agents for semiconductor substrates have been proposed to enable microfabrication, including hexamethyldisilazane (HMDS) and the silane monomer compounds described in JP-A 58-188132, JP-A 9-102458 and JP-A 10-270306. Such silane monomer compounds, though well-adapted for use on the silicon substrates and silicon oxide substrates generally employed in semiconductor applications, have inadequate adhesive strength on substrates composed of a metal or metal oxide, such as copper substrates. As a result, pattern delamination often occurs when high aspect ratio patterns are formed. The reason is that a monomer compound differs in surface treating ability or reactivity depending on its compatibility with the substrate.

### SUMMARY OF THE INVENTION

It is therefore an object of the invention to provide a resist pattern surface treatment agent capable of enhancing adhesion between a metal or metal oxide substrate and a photoresist film. Another object of the invention is to provide a patterning process which uses such a treatment agent.

We have found that silicon-containing oligomeric or polymeric compounds bearing certain types of functional groups greatly increase the adhesion between a photoresist film and a metal or metal oxide substrate.

Accordingly, the invention provides a surface treatment agent which, when applied to a substrate prior to formation of a resist pattern thereon, strengthens adhesion between the substrate and the resist pattern. The surface treatment agent comprises one or more compounds of the following compositional formula:

R¹R²ₐ(OX)_{b}SiO_{(3-a-b)/2} (1)

wherein R¹ is a —(CH₂)ₙY moiety in which Y is epoxycyclohexyl, glycidoxy, N-β-aminoethylamino, amino, N-phenylamino, mercapto or isocyanate, and n is an integer from 0 to 4; R² is a monovalent hydrocarbon group of 1 to 4 carbons; X is hydrogen or a monovalent hydrocarbon group of 1 to 4 carbons; “a” is 0 or 1, and “b” is 0, 1 or 2 when “a” is 0, and “b” is 0 or 1 when “a” is 1.

The invention also provides a patterning process comprising the steps of applying the foregoing surface treatment agent to a substrate and baking, then applying thereon a photoresist composition and patterning the photoresist

### DETAILED DESCRIPTION OF THE INVENTION

The surface treatment agent of the present invention is a composition containing at least one compound of the compositional formula (1).

R¹R²ₐ(OX)_{b}SiO_{(3-a-b)/2} (1)

In formula (1), R¹ is a —(CH₂)ₙY moiety wherein Y is epoxycyclohexyl, glycidoxy, N-β-aminoethylamino, amino, N-phenylamino, mercapto or isocyanate; and n is an integer from 0 to 4. Also, R² is a monovalent hydrocarbon group of 1 to 4 carbons, and X is hydrogen or a monovalent hydrocarbon group of 1 to 4 carbons. The letter “a” is 0 or 1. The letter “b” is 0, 1 or 2 when “a” is 0; and “b” is 0 or 1 when “a” is 1. Illustrative examples of monovalent hydrocarbon groups of 1 to 4 carbons suitable as R² or X include alkyl groups such as methyl, ethyl, propyl and butyl; and alkenyl groups such as vinyl and allyl. Illustrative examples of moieties suitable as R¹ include β-(3,4-epoxycyclohexyl)ethyl, γ-aminopropyl, γ-mercaptopropyl, γ-isocyanatepropyl, N-β-(aminoethyl)-γ-aminopropyl, γ-glycidoxypropyl and N-phenyl-γ-aminopropyl.

According to one aspect of the invention, the compound represented by above compositional formula (1) may be prepared by hydrolyzing a silane of the general formula:

R¹R²ₐSi(OZ)_{c} (2)

In formula (2), R¹, R² and “a” are as defined above; Z is a monovalent hydrocarbon group of 1 to 4 carbons; and “c” is a number which satisfies the condition a+c=3.

Hydrolysis may be carried out by a conventional process. One exemplary process involves diluting a silane monomer compound of formula (2) in a solvent, followed by the addition of water, heating and hydrolysis at about 5 to 100° C. for about 1 to 24 hours, and subsequent polymerization. Any solvent which has sufficient solvency with respect to the inventive surface treatment agent and provides good film formability may be used in hydrolysis. Illustrative, non-limiting examples of such solvents include alcohols such as methanol, ethanol, propanol and isopropanol; aromatic solvents such as toluene and xylene; esters such as ethyl acetate and ethyl lactate; and ketones such as acetone and methyl ethyl ketone.

The compound of above formula (1) or the hydrolytic condensate (an oligomer or a polymer) prepared by hydrolyzing a silane of above formula (2) has preferably not more than 200 silicon atoms, and most preferably not more than 50 silicon atoms, on the molecule.

The inventive surface treatment agent may be prepared as a solution of the formula (1) compound in the above-described solvent, in which case the concentration of the formula (1) compound is preferably set within a range of 0.001 to 5 wt %, and especially 0.005 to 1 wt %. At a concentration below 0.001 wt %, a sufficient improvement in the adhesive strength may not be achieved. On the other hand, a concentration above 5 wt % may result in such a large increase in adhesive strength as to significantly and undesirably lower the resolution when patterning is carried out using the photoresist, rendering the composition unfit for use as a surface treatment agent for enhancing adhesive strength in the target applications.

The surface treatment agent of the invention may also include a small amount of other constituents such as dyes, pigments and surfactants.

The inventive surface treatment agent is typically spin-coated onto the substrate prior to the application of photoresist, and baked at 80 to 120° C. Next, a photoresist composition is applied onto the baked surface and patterning is carried out, thereby forming a pattern having excellent adhesive strength to the substrate. The method for applying the surface treatment agent is preferably spin coating rather than the vapor exposure processes described in the prior art because the vapor exposure processes are only able to apply monomer components and thus cannot provide a sufficient adhesive strength.

Examples of suitable substrates include metal or metal oxide substrates in which the metal is aluminum, iron, nickel, copper, tantalum or gold. The inventive surface treatment agent can generally be applied onto the substrate to a thickness of up to 0.1 μm. Any known photoresist composition may be employed, although the use of a composition containing a base polymer such as novolak resin or polyhydroxystyrene resin is preferred. Patterning itself may be carried out by any conventional method.

The surface treatment agent of the invention markedly improves adhesion between a metal substrate and a resist pattern because the Y group and OX group in above formula (1) are effective even on metal substrates which, unlike silicon substrates, have no hydroxyl groups on the surface. The mechanism involved is as follows. After the surface treatment agent has been coated onto the substrate, the applied coat absorbs moisture from the air during the baking operation, converting OX groups in the surface treatment agent to OH groups. The OH groups then react with the substrate, transforming what was originally an inorganic surface into an organic surface, and thereby enhancing the adhesive strength with photoresist. The Y groups also have an adhesive strength-enhancing effect owing both to coordination by polar residues present in the Y group with the substrate, and to interactions between the polar residues and the resin (base polymer) of which the photoresist film is primarily composed. Such synergistic effects dramatically improve adhesion between metal substrates and the resist pattern. Moreover, the use of an oligomeric or polymeric component enables stable effects to be achieved without evaporation of the component during baking and other operations following application of the surface treatment agent.

### EXAMPLES

The following examples are provided to illustrate the invention and are not intended to limit the scope thereof. All percents are by weight.

### Synthesis Example 1

A four-necked flask equipped with a stirrer, a condenser, a dropping funnel and a thermometer was charged with 25.0 g (0.11 mol) of γ-aminopropyltriethoxysilane and 250 g of isopropanol. The flask contents were stirred to uniformity at room temperature, after which 3.0 g (0.17 mol) of water was added and stirring was continued at room temperature for 1 hour. The mixture was then heated on an oil bath, refluxed for 3 hours, and allowed to cool, after which 225 g of isopropanol was added, yielding 500 g of a 5% solution of surface treatment agent A.

### Synthesis Examples 2 and 3

Surface treatment agents B and C shown in Table 1, each having concentrations of 5%, were prepared in the same manner as in Synthesis Example 1.

TABLE 1

| | | Surface |
|---|---|---|
| Synthesis | | treatment |
| example | Starting silane monomer compound | agent (5%) |
| 1 | γ-aminopropyltriethoxysilane | A |
| 2 | γ-mercaptopropyltriethoxysilane | B |
| 3 | γ-aminopropyltriethoxysilane/ | C |
| | γ-mercaptopropyltriethoxysilane = 50/50 | |

### Example 1

Surface treatment agent A was diluted to a concentration of 1% with isopropanol. The resulting dilution was applied onto a 6-inch copper-sputtered silicon substrate with a spin coater at 3,000 rpm, following which the coated substrate was baked over a hot plate at 110° C. for 120 seconds. A positive photoresist composition (manufactured by Shin-Etsu Chemical Co., Ltd; SIPR-9270-6.0) was then applied to the treated substrate at 3,000 rpm and subjected to a 80° C., 120-second prebake, thereby forming a 6.4 μm thick film. The film was exposed in an i-line stepper (manufactured by Nikon Corporation; NSR-1755i7A; NA= 0.50) and developed with 2.38% tetramethylammonium hydroxide developer to form a pattern. A 1.5-μm line-and-space pattern was evaluated for resolution based on the presence or absence of scum, and for adhesion based on the presence or absence of pattern flow. The results are presented in Table 2.

### Examples 2 to 6, and Comparative Examples 1 to 5

Surface treatment agents A to C obtained in Synthesis Examples 1 to 3 were prepared to various concentrations and evaluated as in Example 1 when applied onto copper substrates and aluminum substrates. Evaluations were similarly carried out in the comparative examples, which included a case in which surface treatment agent was not used, a case involving surface treatment with hexamethyldisilazane (HMDS), a case involving treatment with γ-chloropropyltrimethoxysilane (D), and a case involving treatment with γ-aminopropyltriethoxysilane (E). The results are shown in Table 2.

TABLE 2

| | | Concentration | Sub- | Pattern | Adhesion to |
|---|---|---|---|---|---|
| | Composition | (%) | strate | resolution | substrate |
| EX1 | A | 1 | Cu | no scum | no pattern |
| | | | | | flow |
| EX2 | A | 5 | Cu | no scum | no pattern |
| | | | | | flow |
| EX3 | A | 0.005 | Al | no scum | no pattern |
| | | | | | flow |
| EX4 | B | 0.5 | Cu | no scum | no pattern |
| | | | | | flow |
| EX5 | C | 1 | Cu | no scum | no pattern |
| | | | | | flow |
| EX6 | C | 0.05 | Al | no scum | no pattern |
| | | | | | flow |
| CE1 | none | — | Cu | no scum | pattern flow |
| | | | | | occurred |
| CE2 | none | — | Al | no scum | pattern flow |
| | | | | | occurred |
| CE3 | HMDS | — | Cu | no scum | pattern flow |
| | | | | | occurred |
| CE4 | D | 1 | Cu | no scum | pattern flow |
| | | | | | occurred |
| CE5 | E | 1 | Cu | no scum | pattern flow |
| | | | | | occurred |

The above results demonstrate that surface treatment agents according to the invention are able to improve adhesion between the substrate and the photoresist film.

Japanese Patent Application No. 2000-021103 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A surface treatment agent which, when applied to a substrate prior to formation of a resist pattern thereon, strengthens adhesion between the substrate and the resist pattern, the surface treatment agent comprising at least one compound of the following compositional formula:
R¹R²ₐ(OX)_{b}SiO_{(3-a-b)/2} (1)
wherein R¹ is a —(CH₂)ₙY moiety in which Y is epoxycyclohexyl, glycidoxy, N-β-aminoethylamino, amino, N-phenylamino, mercapto or isocyanate, and n is an integer from 0 to 4; R² is a monovalent hydrocarbon group of 1 to 4 carbons; X is hydrogen or a monovalent hydrocarbon group of 1 to 4 carbons; “a” is 0 or 1, and “b” is 0, 1 or 2 when “a” is 0, and “b” is 0 or 1 when “a” is 1.

2. The surface treatment agent of claim 1, wherein the compound of compositional formula (1) is prepared by hydrolyzing a silane of general formula (2):
R¹R²ₐSi(OZ)_{c} (2)
wherein R¹, R² and “a” are as defined above; Z is a monovalent hydrocarbon group of 1 to 4 carbons; and “c” is a number which satisfies the condition a+c=3.

3. The surface treatment agent of claim 1, wherein R¹ is selected from the group consisting of β-(3,4-epoxy-cyclohexyl)ethyl, γ-aminopropyl, γ-mercaptopropyl, γ-isocyanatepropyl, N-β-(aminoethyl)-γ-aminopropyl, γ-glycidoxypropyl and N-phenyl-γ-aminopropyl.

4. A patterning process comprising the steps of applying the surface treatment agent of claim 1 to a substrate and baking, then applying thereon a photoresist composition and patterning the photoresist.

5. The patterning process of claim 4, wherein the substrate is a metal or metal oxide substrate.

6. The patterning process of claim 5, wherein the metal or metal oxide making up the substrate is aluminum, iron, nickel, copper, tantalum, gold, or an oxide thereof.
